(19) United States
(12) Patent Application Publication
(10) Pub. No.: US 2015/0293326 A1
(43) Pub. Date: Oct. 15, 2015

(54) Tactical Mirror

(71) Applicant: Matthew Payne, Kansas City, MO (US)

(72) Inventor: Matthew Payne, Kansas City, MO (US)

(21) Appl. No.: 14/679,301

(22) Filed: Apr. 6, 2015

Related U.S. Application Data
(60) Provisional application No. 61/977,507, filed on Apr. 9, 2014.

(51) Int. Cl. G02B 7/182

(52) U.S. Cl. CPC G02B 7/182

(57) ABSTRACT

A tactical mirror broadly includes a handle, a grip and a claw. The handle may comprise a telescoping inner and outer handle. The tactical mirror may also include a support arm and a mirror disposed on the support arm to enable visualizing around corners, in holes, under obstacles, or the like.

### RELATED APPLICATIONS

This application claims the benefit of U.S. Provisional Patent Application No. 61/977,507, filed Apr. 9, 2014 that is incorporated by specific reference in its entirety herein.

### FIELD OF THE INVENTION

This present invention relates to devices and methods for safely visualizing into narrow or potentially dangerous locations. More particularly, the invention relates to tactical mirrors used by law enforcement, security, military or first responders.

### BACKGROUND

Law enforcement, security, military personnel, and first responders are often faced with situations where they must enter dangerous or confined locations and many times they must search the same areas for survivors or suspects. In search and rescue situations, a survivor may be between or beyond a narrow opening or trapped under debris. When searching for a criminal suspect or enemy combatant, the fleeing suspect or combatant may hide under motor vehicles, in dark rooms, or in other generally concealed areas. In many cases it is difficult or dangerous to directly visualize a survivor, suspect, or combatant because it would be impractical or potentially dangerous.

One solution to the above-described problems include robots. Robots are useful but are not always practical because they can be too large to fit into some of the narrow places where first-responders must look. Robots are also expensive and, thus, cannot be easily afforded by local police departments, local fire departments, or the like. Additionally, because of their size, robots are also not always present at the scene of a rescue or confrontation when needed and, thus, can cause critical delays in performing the needed operation(s).

### SUMMARY

The present invention solves the above-described problems and provides a distinct advance in the art of safety gear for law enforcement, security, military and first responders. The problem of visualizing into hazardous, dark or confined areas is broadly solved by attaching a mirror on a telescoping pole. In a first embodiment, a tactical mirror includes a handle, a support arm, and a claw. The handle is an extended cylinder for grasping and manipulating the tactical mirror and includes a grip, and a neck. The neck extends from the handle and, in this embodiment, further includes a telescoping arm and a collar.

The support arm extends from the handle and includes an angled mount. The angled mount bends at approximately a 45-degree angle toward the distal end of the handle.

The claw extends from the handle and includes a hook and an accessory mount at opposing ends. The hook is operable to open doors, close doors, move objects, or the like. The accessory mount is operable to removably secure various accessories thereto, such as a flashlight.

In use, a mirror and a flashlight may be removably secured to the tactical mirror. The telescoping arms may be extended, the flashlight may be then set to illuminate, and a user may visualize a reflection of objects generally at a right angle from the mirror. The tactical mirror may also be used to push open doors, to lift objects, to search in blind corners in the dark, to peer down holes, to search through and lift debris, or the like. When complete, the tactical mirror may be collapsed and stored.

### BRIEF DESCRIPTION OF THE DRAWING FIGURES

Embodiments of the present technology are described in detail below with reference to the attached drawing figures, wherein:

FIG. 1 is a front elevational view of a tactical mirror constructed in accordance with a first embodiment of the invention;

FIG. 2 is a right elevational view of the tactical mirror of FIG. 1;

FIG. 3 is a bottom elevational view of the tactical mirror of FIG. 1;

FIG. 4 is a perspective view of the tactical mirror of FIG. 1;

FIG. 5 is a front exploded view of the tactical mirror of FIG. 1;

FIG. 6 is a perspective view of the tactical mirror of FIG. 1;

FIG. 7 is a front elevational view of the tactical mirror of FIG. 1 in a retracted position;

FIG. 8 is a front elevational view of the tactical mirror of FIG. 1 in a partially-extended position; and

FIG. 9 is a front elevational view of the tactical mirror of FIG. 1 in a fully-extended position.

The drawing figures do not limit the present invention to the specific embodiments disclosed and described herein. The drawings are not necessarily to scale, emphasis instead being placed upon clearly illustrating the principles of the technology.

### DETAILED DESCRIPTION

The following detailed description of various embodiments of the present technology references the accompanying drawings that illustrate specific embodiments in which the technology can be practiced. The embodiments are intended to describe aspects of the technology in sufficient detail to enable those skilled in the art to practice them. Other embodiments can be utilized and changes can be made without departing from the scope of the technology. The following detailed description is, therefore, not to be taken in a limiting sense. The scope of the present technology is defined only by the appended claims, along with the full scope of equivalents to which such claims are entitled.

Note that in this description, references to “one embodiment” or “an embodiment” mean that the feature being referred to is included in at least one embodiment of the present invention. Further, separate references to “one embodiment” or “an embodiment” in this description do not necessarily refer to the same embodiment; however, such embodiments are also not mutually exclusive unless so stated, and except as will be readily apparent to those skilled in the art from the description. For example, a feature, structure, act, etc. described in one embodiment may also be included in other embodiments. Thus, the present invention can include a variety of combinations and/or integrations of the embodiments described herein.

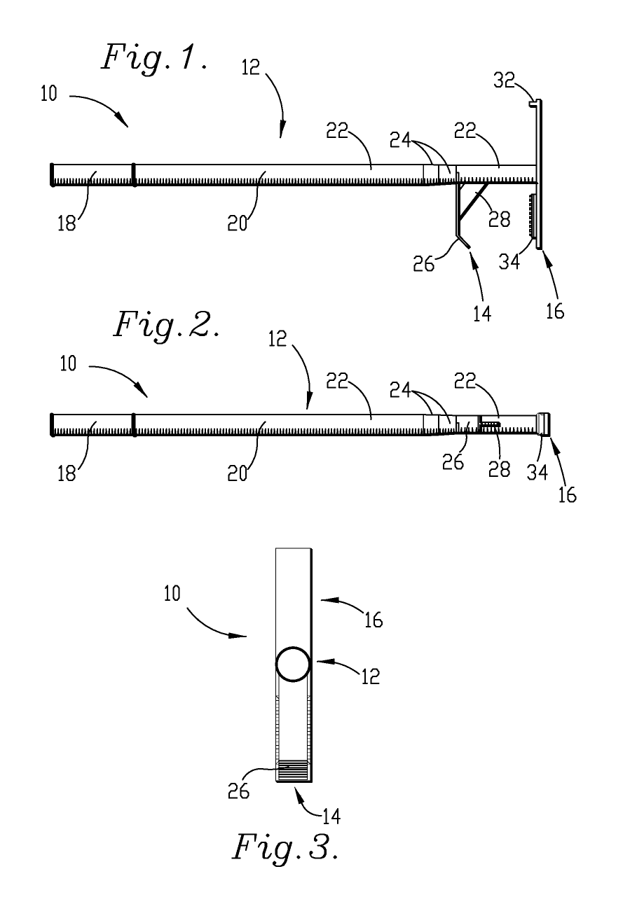

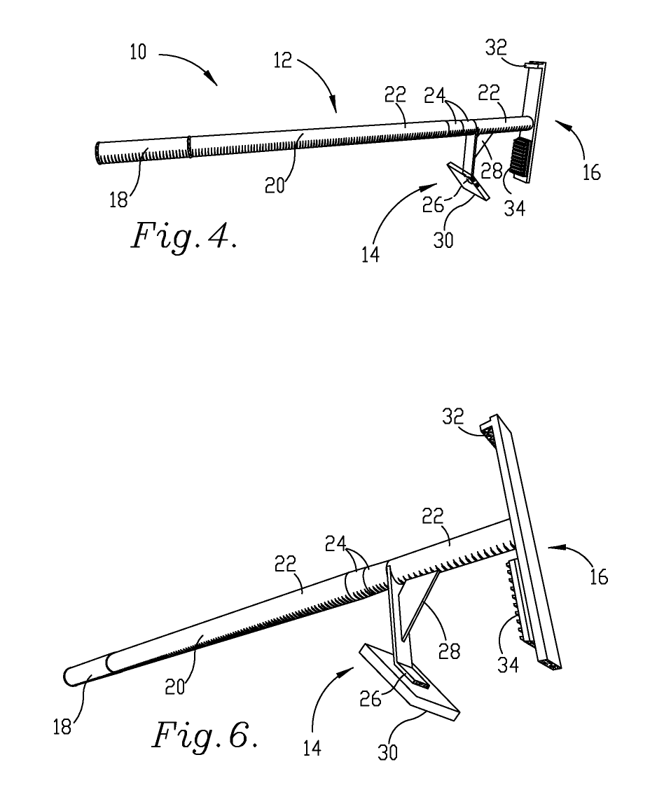

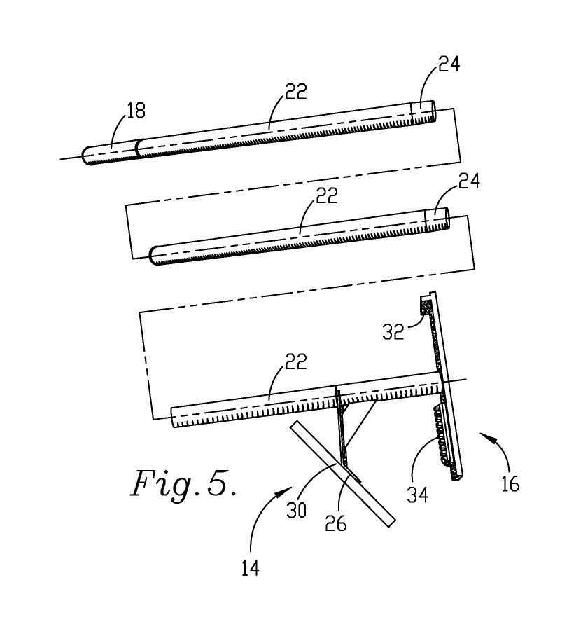

Turning now to the drawing figures and, in particular FIGS. 1-6, a tactical mirror 10 for looking around corners, into attics, under cars, into compact spaces, or the like, broadly includes a handle 12, a support arm 14, and a claw 16. In this embodiment, the various components of the tactical mirror 10 are fabricated from aluminum, but in other embodiments, each component may be fabricated from various metals, composite materials, nylons, plastics, woods, or the like. In other embodiments, one component may be fabricated from a first material and a second component may be fabricated from a second material, or combination of materials, without deviating from the anticipated scope of the invention.

In this embodiment, the handle 12 is an extended cylinder for grasping and manipulating the tactical mirror 10. In this embodiment, the handle 12 further includes a grip 18, and a neck 20. The grip 18 is at the proximal end of the handle 12 and may further include a knurled outer surface, ridges, engraved patterns, a non-slip coating, an elastomeric sleeve, or the like, to prevent slippage when manipulating the tactical mirror 10. The neck 20 extends from the grip 18 to the distal end of the handle 12 and, in this embodiment, further includes a telescoping arm 22 and a collar 24 for selectively increasing the length of the handle 12 while retaining the ability to compact for easy storage. In this embodiment, the collar 24 is cylindrical and is operable to tighten the arm 22 in place by rotating the collar 24 circumferentially around the handle 12. In other embodiments, various other mechanisms may be used including levers, pins, retractable nubs, or the like to secure each arm 22.

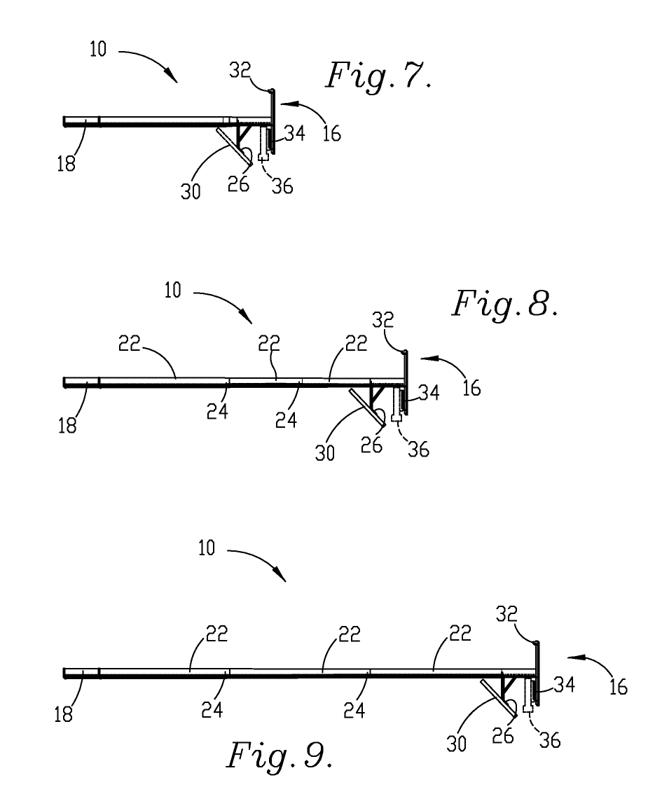

The support arm 14 extends generally perpendicular from the handle 12 between then grip 18 and the claw 16 and further includes an angled mount 26 at the distal end of the support arm 14. The angled mount 26 extends from the support arm 14 at approximately a 45-degree angle toward the distal end of the tactical mirror 10. In this embodiment, the support arm 14 also includes fin 28 for strengthening the support arm 14. In some embodiments the angled mount 26 further includes a hole, a clip, a flange, surface features, or the like, for securing accessories thereto. As shown in FIGS. 7-9, a mirror 30 may be secured to the support arm to allow for indirectly visualizing around corners, in holes, under objects, or the like. In some embodiments of a tactical mirror 10, the mirror may be convex, flax, or concave, depending on the circumstances or needs of the user.

The claw 16 extends from the distal end of the handle 12 in a generally parallel direction to the support arm 14 and further includes a hook 32 and an accessory mount 34 at opposing ends on the proximal side of the claw 16. The hook 32 is operable to open doors, close doors, move objects, or the like. The accessory mount 34 is operable to removably secure various accessories thereto. As shown in FIGS. 7-9, a flashlight 36 may be secured to the accessory mount for providing light around dark corners, in holes, under objects, or the like. The position of the accessory mount 34 enables a user to removably affix a flashlight thereto and removably affix the mirror 30 to the angled mount 26 and have a light source shining parallel to, and generally incident to, the a users line of sight, as reflected in the mirror 30.

Turning now to FIGS. 7-9, in use, a mirror 30 and a flashlight 36 may be removably secured to the tactical mirror 10 on the support arm 14 and the accessory mount 34, respectively. Then each collar 24 may be twisted in a first direction to loosen a corresponding telescoping arm 22. Each telescoping arm 22 may then be slid outward to increase the overall length of the tactical mirror 10 and then the corresponding collar 24 may be twisted in a second direction to secure the telescoping arm 22 in place. The flashlight 36 may be then set to illuminate and a user may visualize a reflection of objects generally at a right angle from the mirror 30. The tactical mirror 10 may further be used to push open doors, to lift objects, to search in blind corners in the dark, to peer down holes, to search through and lift debris, or the like. When user of the tactical mirror 10 is complete, the tactical mirror 10 may be collapsed by substantially reversing this procedure.

Although the invention has been described with reference to the preferred embodiment illustrated in the attached drawing figures, it is noted that equivalents may be employed and substitutions made herein without departing from the scope of the invention as recited in the claims.

What is claimed is:

1. A tactical mirror comprising:
a handle,
a grip disposed on a proximal end of the handle, and
a claw disposed on a distal end of the handle.

2. The tactical mirror of claim 1, the handle further comprising:
an outer handle, and
an inner handle, wherein the inner handle is received within the outer handle,
wherein the grip is disposed on a proximal end of the outer handle, and
wherein the claw is disposed on a distal end of the inner handle.

3. The tactical mirror of claim 2, the handle further comprising:
a collar disposed on a distal end of the outer handle and operable to selectively transition from a secured position to an unsecured position,
wherein the inner handle may be extended or retracted relative to the outer handle when the collar is in the unsecured position, and
wherein the inner handle is fixed in position relative to the outer handle when the collar is in the secured position.

4. The tactical mirror of claim 1, the tactical mirror further comprising:
a support arm extending generally perpendicular from the handle,
wherein the claw is extends generally perpendicular from the handle and substantially parallel to the support arm.

5. The tactical mirror of claim 4, the support arm further comprising:
an angled mount disposed on a lateral end of the support arm.

6. The tactical mirror of claim 4, the support arm further comprising:
a fin disposed between the handle and the support arm and operable to strengthen the support arm.

7. The tactical mirror of claim 1, the claw further comprising
a hook, and
an accessory mount disposed on a proximal side of the claw.

8. The tactical mirror of claim 7, wherein:
the hook and the accessory mount are disposed on opposing ends of the claw.

9. The tactical mirror of claim 4, further comprising:
a mirror disposed on the support arm.

10. The tactical mirror of claim 1, wherein the grip is knurled metal.

11. A tactical mirror comprising:
a handle,
a grip disposed on a proximal end of the handle,
a claw disposed on a distal end of the handle and extending generally perpendicular from the handle, and
a support arm disposed on the handle between the grip and the claw and extending generally perpendicular from the handle,
wherein the claw is substantially parallel to the support arm.

12. The tactical mirror of claim 11, the handle further comprising:
an outer handle, and
an inner handle,
wherein the inner handle is received within the outer handle,
wherein the grip is disposed on a proximal end of the outer handle,
wherein the claw is disposed on a distal end of the inner handle, and
wherein the support arm is disposed on the inner handle proximal to the claw.

13. A tactical mirror comprising:
a handle,
a support arm disposed on the handle and extending generally perpendicular from the handle, and
a claw disposed on a the handle and extending generally parallel to the support arm.

14. The tactical mirror of claim 13, the claw further comprising:
a hook disposed on a first end of the claw, and
an accessory mount disposed near a second end of the claw.

15. The tactical mirror of claim 14, the accessory mount comprising an angled mount disposed on a distal end of the accessory mount and extending at a generally 45 degree angle from the accessory mount.

16. The tactical mirror of claim 15 further comprising a mirror disposed on a proximal side of the angled mount.

17. The tactical mirror of claim 13 further comprising a fin disposed between the handle and the support arm.

18. A tactical mirror comprising:
an outer handle,
an inner handle disposed at least partially within the outer handle and operable to be received within the outer handle in a telescoping fashion,
a collar disposed on a distal end of the outer handle operable to selectively transition from a secured position to an unsecured position,
a grip disposed on a proximal end of the outer handle,
a claw disposed on a distal end of the handle and extending generally perpendicular from the handle, the claw including an accessory mount disposed on a proximal side of the claw, and
a support arm disposed on the handle between the grip and the claw and extending generally perpendicular from the handle, the support arm including an angled mount disposed on an end of the support arm.
wherein the claw is substantially parallel to the support arm,
wherein the inner handle may be extended or retracted relative to the outer handle when the collar is in the unsecured position, and
wherein the inner handle is fixed in position relative to the outer handle when the collar is in the secured position.

19. The tactical mirror of claim 18, further comprising a hook disposed on the claw.

20. The tactical mirror of claim 18, further comprising a mirror disposed on the angled mount.
